(19) United States
(12) Patent Application Publication
(10) Pub. No.: US 2002/0072346 A1
(43) Pub. Date: Jun. 13, 2002

(54) Method and apparatus for error vector magnitude reduction

(75) Inventors: Shuzo Kato, San Diego, CA (US); Kiyotaka Ogata, San Diego, CA (US)

Correspondence Address: LYON & LYON LLP, 633 WEST FIFTH STREET, SUITE 4700, LOS ANGELES, CA, 90071, US

(73) Assignee: MITSUBISHI WIRELESS COMMUNICATIONS, INC.

(21) Appl. No.: 09/735,993

(22) Filed: Dec. 12, 2000

(51) Int. Cl. H04Q 7/20

(52) U.S. Cl. 455/403; 455/67.1; 455/423

(57) ABSTRACT

A predetermined error vector magnitude reduction circuit exploits scatter patterns that develop at the output of modem wireless communication systems during phase state transition. Digital inphase and quadrature input signals to the circuit, typically from a baseband processor, are compared to known characteristic bit patterns that are pre-stored in a lookup table. Modified data that correspond to the known characteristic bit patterns is supplied to the circuit to replace the data signals themselves. The modified data may be digital data that replaces the digital signals at the input to the inphase and quadrature DACs, or analog data that replaces the analog output of the DACs.

### FIELD OF THE INVENTION

The present invention relates generally to wireless communications, but more specifically to methods and systems for error vector magnitude reduction.

### BACKGROUND OF THE INVENTION

Wireless communication systems are an integral component of the ongoing technology revolution. In fact, mobile radio communication systems, such as cellular telephone systems, are evolving at an exponential rate. In a cellular system, a coverage area is divided into a plurality of “cells.” A cell is the coverage area of a base station or transmitter. Low power transmitters are utilized, so that frequencies used in one cell can also be used in cells that are sufficiently distant without interference. Hence, a cellular telephone user, whether mired in traffic gridlock or attending a meeting, can transmit and receive phone calls so long as the user is within a “cell” served by a base station.

One implementation of a cellular network 100 is depicted in block form in FIG. 1. The network 100 is divided into four interconnected components or subsystems: a Mobile Station (MS) 106, a Base Station Subsystem (BSS) 102, a Network Switching Subsystem (NSS) 104, and an Operation Support Subsystem (OSS) 118. Generally, MS 106 is the mobile equipment or phone carried by the user. BSS 102 interfaces with multiple mobiles to manage the radio transmission paths between MSs 106 and NSS 104. In turn, NSSs 104 manages system-switching functions and facilitates communications with other networks such as the PSTN and the ISDN. OSS 118 facilitates operation and maintenance of the network.

MSs 106 communicate with BSS 102 across a standardized radio air interface 108. BSS 102 is comprised of multiple base transceiver stations (BTS) 110 and base station controllers (BSC) 114. A BTS 110 is usually in the center of a cell and consists of one or more radio transceivers with an antenna. It establishes radio links and handles radio communications over the air interface with MSs 106 within the cell. The transmitting power of the transceiver defines the size of the cell. Each BSC 102 manages multiple transceivers. The total number of transceivers per a particular controller could be in the hundreds. The transceiver-controller communication is over a standardized “Abis” interface 112. BSC 102 allocates and manages radio channels and controls handovers of calls between its transceivers.

BSC 102, in turn, communicates with NSS 104 over a standardized interface 116. For example, in a GSM system, which will be discussed infra, the interface uses an SS7 protocol and allows use of base stations and switching equipment made by different manufacturers. A Mobile Switching Center (MSC) 122 is the primary component of NSS 104. MSC 122 manages communications between mobile subscribers and between mobile subscribers and public networks 130. Examples of public networks 130 that the mobile switching center may interface with include Integrated Services Digital Network (ISDN) 132, Public Switched Telephone Network (PSTN) 134, Public Land Mobile Network (PLMN) 136, and Packet Switched Public Data Network (PSPDN) 138.

MSC 122 typically will interface with several databases to manage communication and switching functions. For example, MSC 122 may interface with Home Location Register (HLR) 124 that contains details on each subscriber residing within the area served by the mobile switching center. There may also be a Visitor Location Register (VLR) 126 that temporarily stores data about roaming subscribers within a coverage area of a particular mobile switching center. An Equipment Identity Register (EIR) 120 that contains a list of mobile equipment may also be included. Further, equipment that has been reported as lost or stolen may be stored on a separate list of invalid equipment that allows identification of subscribers attempting to use such equipment. Finally, there may be an Authorization Center (AuC) 128 that stores authentication and encryption data and parameters that verify a subscriber's identity.

There are several technologies in use today for different implementations of cellular network 100. When wireless telecommunications began in North America back in the 1950s, an analogue standard called Advanced Mobile Phone Service (AMPS) was used. AMPS operated in the frequency spectrum from 824 to 894 MHz. This spectrum was then divided into 30 KHz channels for use by MSs 106 within cellular network 100. In order to allow full duplex operation, a 30 Khz channel is reserved for each MS 106 to transmit on, and a 30 KHz channel is reserved for each MS 106 to receive on. These two channels are separated within the frequency spectrum by 45 MHz. Thus, a MS 106 transmitting on a channel at 831.21 MHz would receive at 876.21 MHz.

Dividing the frequency spectrum into multiple equally spaced channels is called Frequency Division Multiple Access (FDMA) and is illustrated in FIG. 2A. As can be seen, there are a limited number of channels 202 that can be used within the fixed frequency spectrum from 824 to 894 MHz. As a result, new technologies were developed in order to increase the capacity (number of channels) that could be supported by a cellular network 100. The first of these technologies was called Narrowband Advanced Mobile Phone Service (NAMPS). The key difference between NAMPS and AMPS is the use of a 10 Khz channel in the former. Thus, the capacity of a NAMPS system is three times the capacity of an AMPS system.

Eventually, digital technologies evolved to address the capacity issue and to improve the quality and functionality of the services provided by cellular network 100. The major difference between digital and analogue is the method used to transmit data between MS 106 and BSS 102. In an analogue scheme, the information is encoded as proportional variations in a frequency modulation (FM). In a digital scheme, the information is first digitized and then encoded using various complex modulation schemes. The modulated signal is then transmitted to BSS 102. Additionally, as a result of the digital schemes and the enhanced features they enable, the frequency spectrum from 1.85 GHz to 1.99 GHz has been allocated for new cellular type services called Personal Communications Service (PCS).

The primary digital technologies used in North American are Time Division Multiple Access (TDMA) and Code Division Multiple Access (CDMA). There are several TDMA technologies currently available in the United States. One is the North American-TDMA system (NA-TDMA), also known as Digital-AMPS (D-AMPS). TDMA employs time slots to put multiple calls on the same channel. As illustrated in FIG. 2B, NA-TDMA uses the same channel scheme as AMPS; however, each channel is divided into six time slots 204a-204f. Each slot is then assigned to a different user. Thus, the capacity of a NA-TDMA system is six times the capacity of an AMPS system and twice the capacity of a NAMPS system. Before 1995, NA-TDMA was governed by the IS-54 standard. IS-54 is being replaced, however, by IS-136, which incorporates implementation in the PCS band, a new Digital Control Channel (DCCH), and new user services.

Another TDMA system that developed in Europe, where a similar transition from analog to digital technologies took place, is the GSM system. GSM has been adopted for use in the United States as PCS1900, which is now offered in the PCS band.

CDMA, on the other hand, is a completely different type of multiple access scheme. In CDMA, channels are not allocated by dividing the spectrum in frequency or time. Instead, a 1.25 MHz channel is used for all users within a cell. The transmission signal is prepared by first digitizing the data and then multiplying the digitized data by a wide-bandwidth pseudo noise code (pn)-sequence. Thus, as illustrated in FIG. 2C, each transmission 206a, 206b, 206c, and 206d appears as noise to all other transmissions. In order to recover the signal at a receiver, each user is given a specific (pn)-sequence that is recognized by that user's MS 106 and BSS 102. Therefore, only transmissions coded using the specific (pn)-sequence are recognized and the rest of the transmissions are regarded as noise.

Both TDMA and CDMA employ a technique known as modulation, which mixes the digital signal bit stream onto a Radio Frequency (RF) carrier of a predetermined frequency prior to the amplification stage of a transmitter. In its modulated form, the signal becomes subject to a host of obstacles as it travels over the airwaves. Dropouts, signal wells, and crossover interference from neighboring channels are familiar mobile communication vulnerabilities that cause annoying disturbance in analog communication, but in the digital realm they make reconstruction of the original signal difficult or impossible. Such difficulties often manifest themselves digitally as misread bits during demodulation by the RF receiver. Conversations or messages transmitted digitally are frequently made undecipherable by a receiver's inability to faithfully reconstruct the bit stream. Thus, it is critical that the modulated signal be as accurate as possible in order to preserve the integrity of the encoded bitstream.

In this regard, one important design parameter of modem wireless systems is a quantity known as the Error Vector Magnitude (EVM). EVM data is gathered near the final stage in a typical RF transmitter, just after signal amplification. EVM is a measure of the amount of overshoot detected at the transmitter output and is usually plotted in the IQ plane. EVM is a root cause of overshoot, which results in errors in the interpretation of phase state transitions. These errors alter the transmitted bit stream when the receiver tries to reconstruct the original signal. EVM can therefore be used as a metric for identifying deviations from ideal state transitions and must be kept to a practical minimum.

### SUMMARY OF THE INVENTION

The present invention comprises a predetermined error vector magnitude reduction circuit that includes the use of a lookup table containing bit patterns, which were predetermined to cause overshoot. These predetermined bit patterns are used to supply modified output data that does not cause overshoot. In one embodiment, modified analog data pre-stored in the lookup table replaces the output of digital-to-analog converters within the circuit. In another embodiment, modified digital bit patterns replace the inputs to the digital-to-analog converters. In either embodiment, the resulting modified output is then fed into a mixing stage or stages of a transmitter. The invention also comprises wireless communication handset that includes a transmitter containing a predetermined error vector magnitude reduction circuit.

A method for pre-loading the lookup table with predetermined characteristic bit patterns derived from offshoot scatter patterns detected during testing of the circuit is also provided. The method may also comprise the steps required to compare the characteristic bit patterns with the input signals and substitute the corresponding modified data for the input signals when a match is made in the lookup table.

Further embodiments and implementations of the invention are also disclosed and are explained in detail below.

### BRIEF DESCRIPTION OF THE DRAWINGS

In the figures of the accompanying drawings, like reference numbers correspond to like elements, in which:

FIG. 1 is a diagram illustrating a typical cellular communications system.

FIG. 2A is a diagram illustrating the channel structure in a FDMA system.

FIG. 2B is a diagram illustrating the channel structure in a TDMA system.

FIG. 2C is a diagram illustrating the channel structure in a CDMA system.

FIG. 3A is a block diagram illustrating a first embodiment of a wireless transmitter.

FIG. 3A is a block diagram illustrating a second embodiment of a wireless transmitter.

FIG. 4 is a diagram illustrating quadrature modulation using quadrature phase shift keying.

FIG. 5 is a constellation diagram illustrating typical phase state transition in quadrature phase shift keying system.

FIG. 6 is a close-up of a portion of the constellation diagram of FIG. 5 illustrating error vector magnitude.

FIG. 7 is a block diagram illustrating a transmitter system with a feedback block.

FIG. 8 is a block diagram illustrating a first embodiment of a predetermined error vector magnitude reduction circuit in accordance with the invention.

FIG. 9 is a block diagram illustrating a second embodiment of a predetermined error vector magnitude reduction circuit in accordance with the invention.

FIG. 10 is a block diagram of a wireless transmitter comprising an error vector magnitude circuit such as the one illustrated in FIG. 8 or FIG. 9.

FIG. 11 is a process flow diagram illustrating a method of predetermined error vector magnitude reduction in accordance with the invention.

FIG. 12 is a process flow diagram illustrating a method of using a lookup table to prevent or reduce error vector magnitude in accordance with the invention.

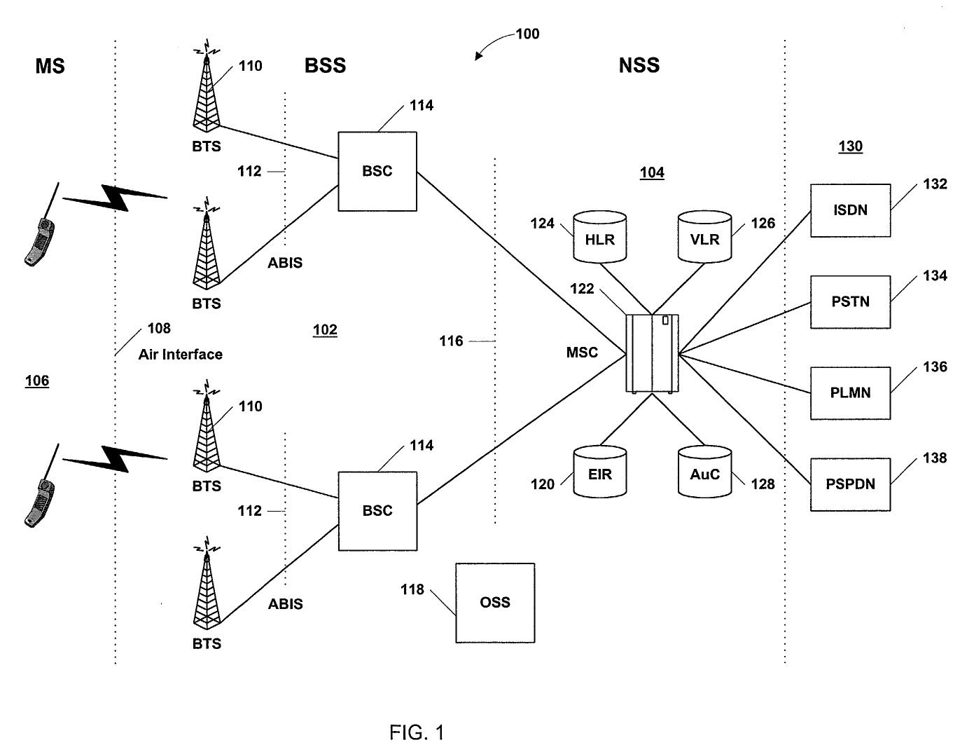

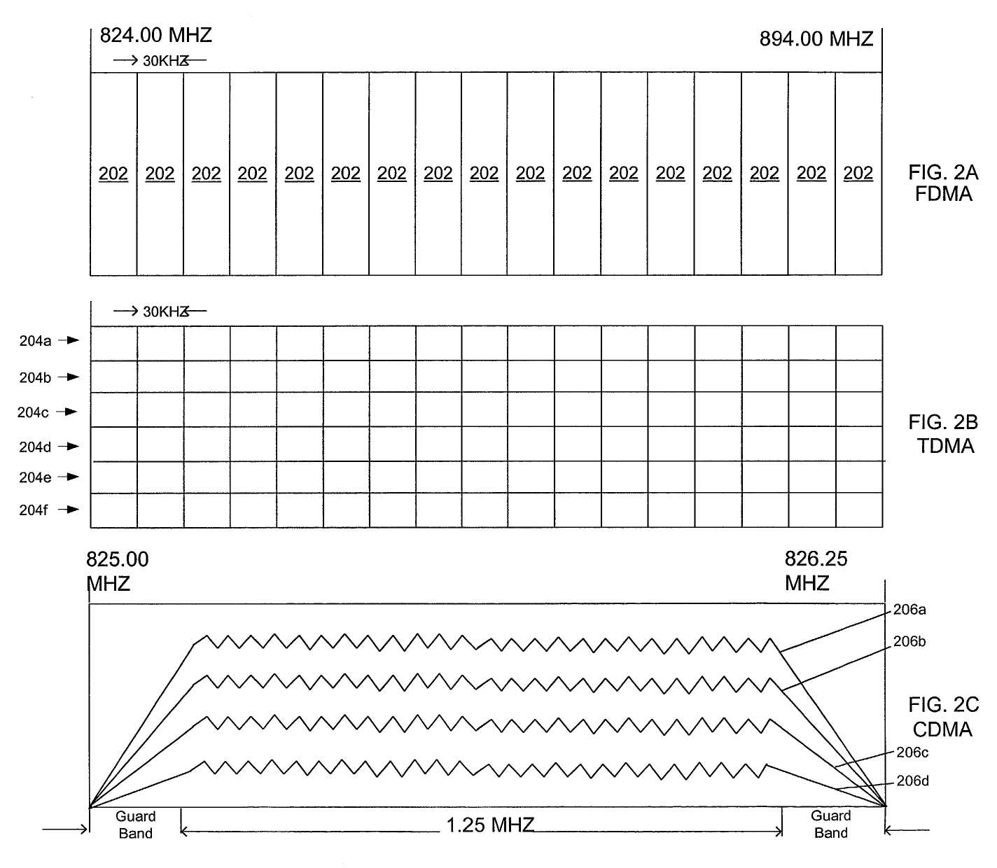

### DETAILED DESCRIPTION

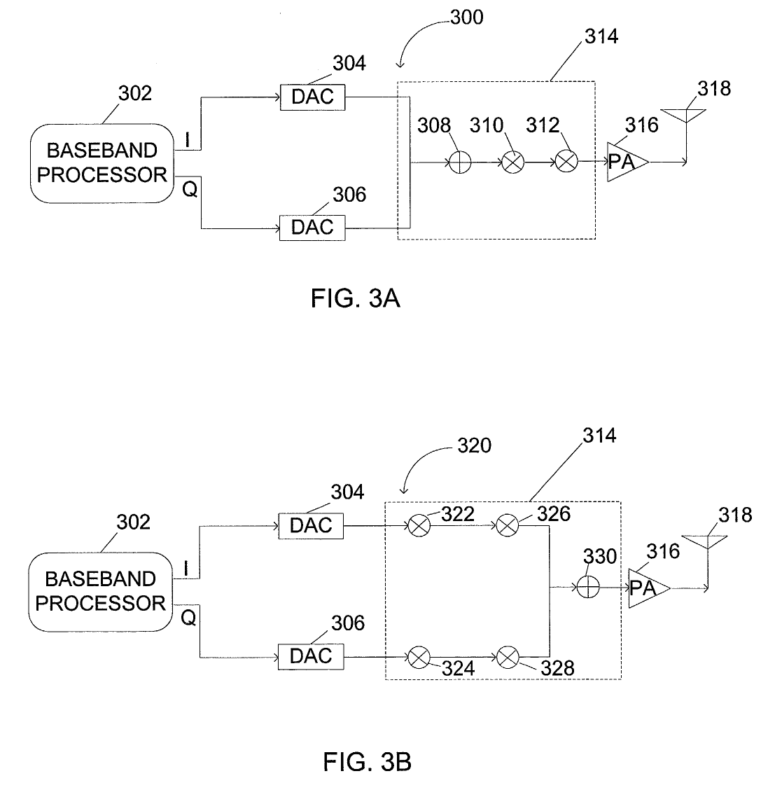

FIG. 3A illustrates a sample embodiment of a transmitter 300 belonging to a mobile station in a wireless communications system. Transmitter 300 comprises a baseband processor 302, which generates digital inphase (I) and quadrature (Q) data signals. These data signals represent information that has undergone coding in the digital domain. Transmitter 300 also includes an inphase Digital-to-Analog Converter (DAC) 304 and a quadrature DAC 306. DACs 304 and 306 transform the inphase and quadrature digital signals into inphase and quadrature analog signals, respectively. In particular, the inphase and quadrature digital undergo Quadrature Phase Shift Keying (QPSK), which is a popular modulation format used in digital wireless phones. QPSK uses the simultaneous transmission of two Phase Shift Keying (PSK) signals where one is in quadrature (shifted in phase by 90°) to the other. Adder 308, which is part of mixing block 314, adds the inphase and quadrature analog signals, producing a single-ended analog signal. Mixing block 314 transforms the single-ended analog signal into an RF signal.

In a direct conversion transmitter, mixing block 314 comprises one mixer 310, which modulates the single-ended analog signal onto an RF carrier signal to produce the RF signal. In a more typical embodiment, transmitter 300 is an Intermediate Frequency (IF) transmitter, which comprises two mixers 310 and 312 within mixing block 314. In this case, mixer 310 mixes the single-ended analog signal up to an IF signal, and mixer 312 mixes the IF signal up to the RF signal. The RF signal is sent to Power Amplifier (PA) 316, which amplifies the RF signal to a sufficient power level for transmission by antenna 318.

An alternative embodiment of a transmitter 320 is illustrated in FIG. 3B. Transmitter 320 is differentiated from transmitter 300 by an alternative configuration of mixing block 314. In this embodiment, the inphase and quadrature signals are mixed up to inphase and quadrature RF signals independently of each other. In a direct conversion transmitter the mixing is done using one inphase RF mixer 322 and one quadrature RF mixer 324. But in an IF transmitter, mixers 322 and 324 are inphase and quadrature IF mixers, which generate inphase and quadrature IF signals. RF mixers 326 and 328 mix the inphase and quadrature IF signals up to inphase and quadrature RF signals. Regardless of whether transmitter 320 is a direct conversion or IF transmitter, the inphase and quadrature RF signals are combined in adder 330 and sent to PA 316 for amplification before transmission by antenna 318.

As mentioned previously, EVM, which is measured at the output of PA 318, is a key design parameter. EVM is due to non-linearity in the transmitter components that are between baseband processor 302 and antenna 318, and mismatches in amplitude and/or phase difference between the inphase and quadrature signal paths. These problems cause the vector magnitude and phase representations of the inphase and quadrature data to be incorrect. The resulting error in the magnitude and/or phase can cause overshoot in the transitions from state to state at the transmitter's output.

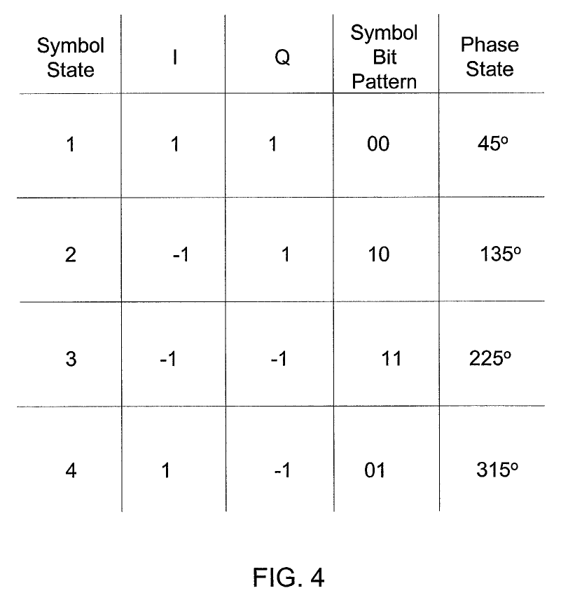

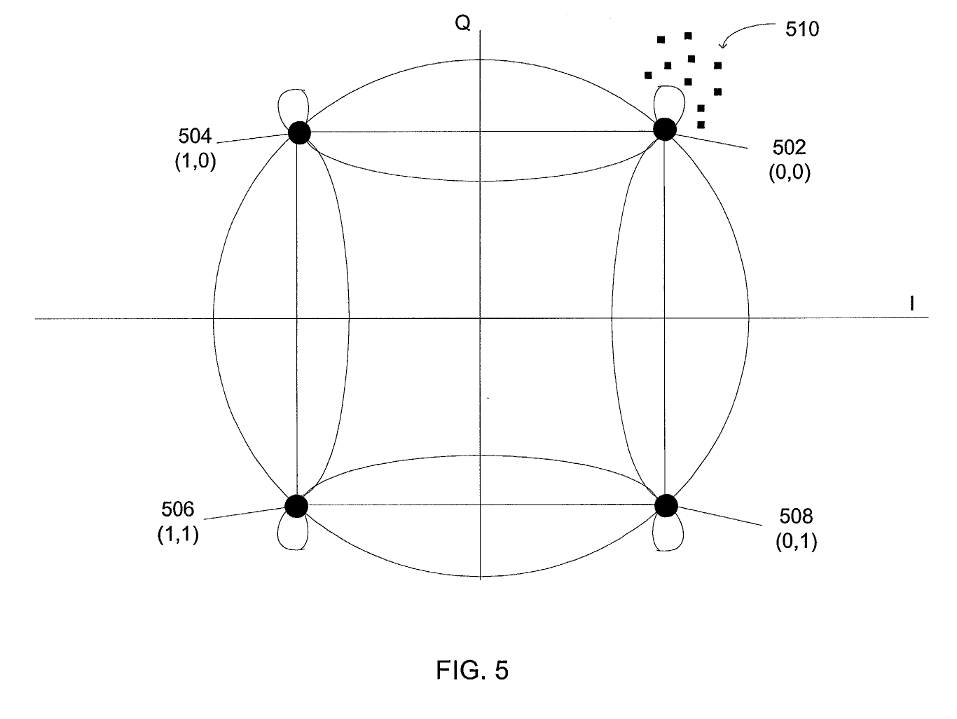

Understanding how phase state transitions can be used to encode digital signals requires a basic knowledge of modulation. QPSK modulation, for example, is a phase shift key scheme used in TDMA systems to encode the bit patterns of a digital signal onto an analog waveform by manipulating the waveform's phase. As illustrated in FIG. 4, QPSK encodes the inphase and quadrature bits into four different symbol states that are represented by a two bit symbol and associated phase. The phase for each state is 90° out of phase with adjacent states. These states can be represented on the constellation diagram of FIG. 5 by points 502, 504, 506, and 508. Ideally, the magnitude of these points is unity. Problems with the linearity of the transmitter will, however, cause errors in the magnitude or phase. Errors in the phase will cause the actual vector position to slew toward the adjacent states as if it was moving along the perimeter of a unit circle. Errors in the magnitude, on the other hand, will cause the vector position to slew in and out along an axis extending from the origin.

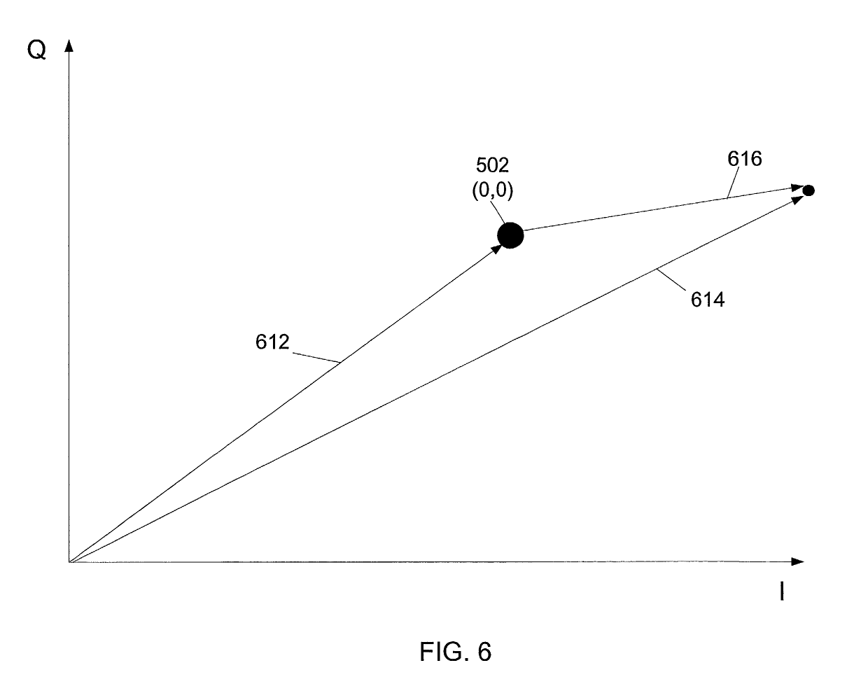

Also illustrated in FIG. 5 are the transitions from state to state. Due to the errors in magnitude and phase, the actual vector position resulting from each transition will not align with the ideal vector position for each state. This misalignment is illustrated more closely in FIG. 6. Thus, the ideal position vector 612 and the actual position vector 614 will not coincide, creating error vector 616. The result of a succession of state transitions will, therefore, be a scatter pattern 510 (FIG. 5) of actual positions and their associated error vectors 616. Certain specific scatter patterns 510 will cause overshoot in the transition from one state to the next and will result in high error rates in the transmitted data.

Existing approaches to EVM minimization have traditionally focused on careful component selection and tolerance adjustments at each stage in the transmitter circuit, as well as attempts at linearization of the amplification stage. Popular linearization techniques include negative feedback, predistortion, and feedforward techniques.

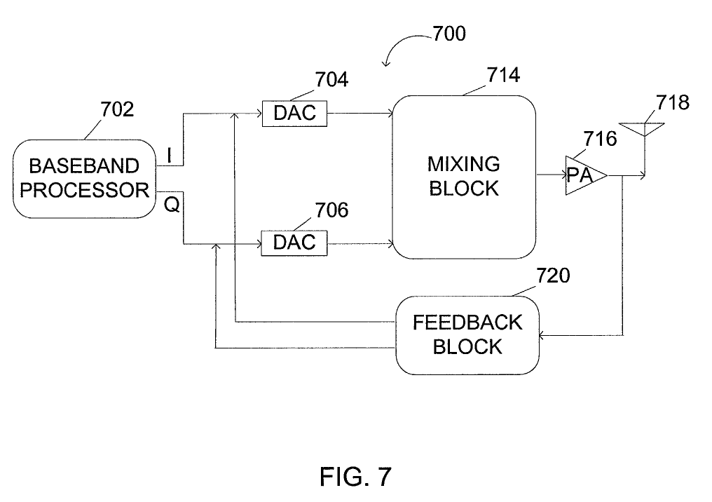

FIG. 7 illustrates a general block diagram of a negative feedback network 700. Feedback block 720 subtracts a portion of the output from PA 716 from a signal at some earlier stage in the system in order to improve system linearity. Negative feedback loops, like the well-known Cartesian Feedback approach, are often deployed in transmitters to improve the linearity of PA 716. This approach, however, has limitations. First, the linearization achieved is dependent upon a close match in both gain and phase between mixing block 714 and feedback block 720. Second, tight control over the components must be guaranteed to ensure the stability of the loop. Finally, feedback techniques undesirably reduce the forward gain of the amplifier stage.

Predistortion is aimed at improving the linearity of PA 716, as well. In predistortion, linearization is achieved by applying distortions to the digital inphase and quadrature data. Distortion coefficients are generated based on known characteristics of PA 716. The coefficients are used for distorting the signal prior to entering the digital-to-analog conversion stage. Adaptive predistortion goes one step further, adding a feedback loop that updates the coefficients by periodically sensing the output of PA 716. Adding the feedback loop, however, subjects the adaptive predistortion method to the same ill side-effects of Cartesian feedback. Additionally, each of the above approaches constantly acts on the digital inphase and quadrature signals in order to improve linearization. Thus, these approaches act at a constant cost to system performance and are not guaranteed to eliminate overshoot. Further, by modifying the digital data, these approaches are introducing incorrect data into the transmitted information.

Feedforward linearization does not use feedback. Instead, an attenuated sample of the output from nonlinear PA 716 is subtracted from a time-delayed version of the input of PA 716, leaving behind only the unwanted frequency components of the output of PA 716. This resulting error signal is then fed into a second amplifier, whose output is subtracted from a time-delayed sample of the output of PA 716, generating a clean signal. A major drawback of the feedforward technique is the required careful matching between the two signal paths. That is, the time delay introduced by the first delay element must closely match the natural time delay introduced by the nonlinear PA in order for the signal subtraction stage to generate a pure error signal. As with the previous approaches, there is no guarantee that overshoot can be avoided. Moreover, each of the above approaches has significant disadvantages in terms of component costs, component area, manufacturing yield, and transmitter performance.

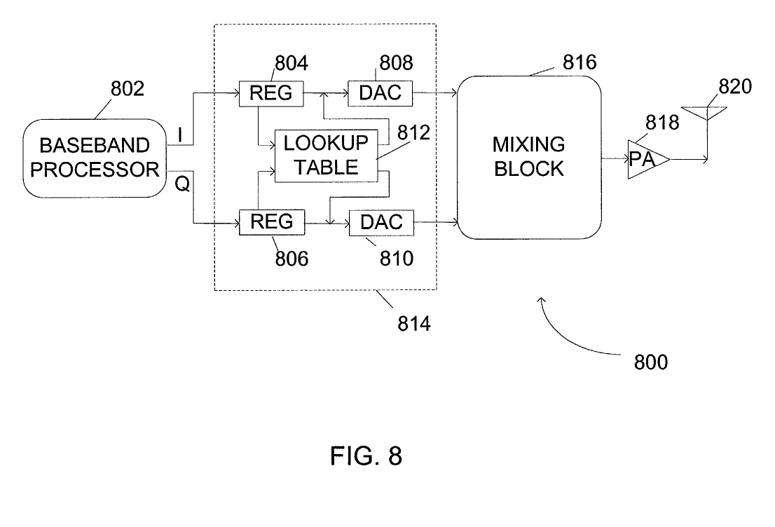

FIG. 8 illustrates a transmitter 800 in accordance with one embodiment of the claimed invention. Transmitter 800 comprises baseband processor 802, which produces digital inphase and quadrature signals and stores these signals in inphase and quadrature registers 804 and 806, respectively. The outputs of registers 804 and 806 are coupled to inphase and quadrature DACs 808 and 810 respectively, the outputs of which are inphase and quadrature analog signals respectively. The analog signals are mixed up to an RF signal in mixing block 816, which can use either direct conversion or IF mixing. The RF signal is amplified by PA 818 and transmitted via antenna 820.

While it is important to ensure that transmitter 800 is designed for maximum linearity, this is not a guarantee that overshoot will not occur. Thus, transmitter 800 includes lookup table 812. Lookup table 812 takes advantage of the fact that overshoot can be correlated to specific overshoot patterns 510 (FIG. 5). Through testing for these patterns 510, correlations to specific digital inphase and quadrature bit patterns can be developed. These specific bit patterns are stored in lookup table 812 as predetermined digital inphase and quadrature bit patterns. In addition, for each of the predetermined inphase and quadrature bit patterns, modified digital inphase and quadrature bit patterns that do not cause overshoot, are stored in lookup table 812.

Therefore, the predetermined and modified bit patterns can be prerecorded in lookup table 812. Lookup table 812 is typically stored in a storage device such as in SRAM, Flash, EPROM, EEPROM, or DRAM. Then, as digital inphase and quadrature data is generated by baseband processor 802, it is stored in registers 804 and 806. The bit patterns stored in registers 804 and 806 are compared with the predetermined bit patterns in table 812. If there is a match, then the modified bit patterns are read out of table 812 and replace the registered bit patterns as the inputs to DACs 808 and 810. In this way, overshoot is avoided.

Alternative embodiments implement lookup table 812 in firmware or in software. Maintaining table 812 in software has the added advantage that table 812 can easily be updated if later testing or performance requires.

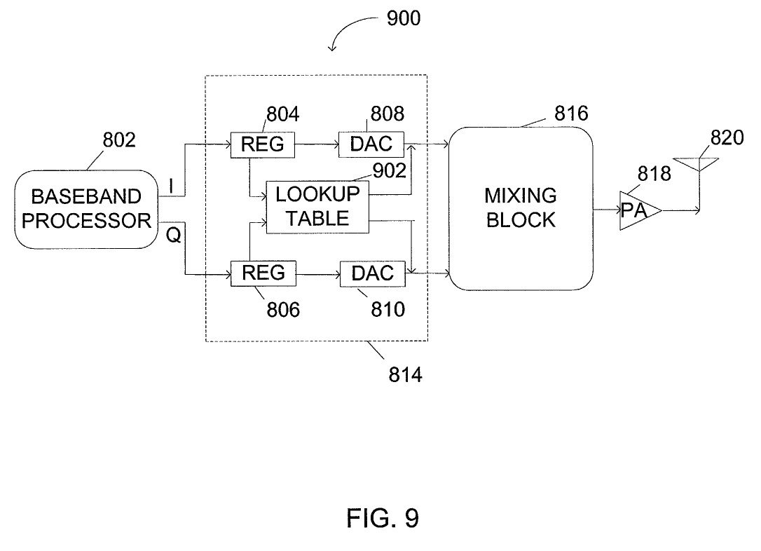

Modifying the digital inphase and quadrature data will, of course, result in the inclusion of erroneous data in the transmitted signal. This can be overcome, however, by the embodiment illustrated in FIG. 9. Transmitter 900, of FIG. 9, includes a slightly different lookup table 902. In lookup table 902, modified analog inphase and quadrature data is stored as opposed to modified digital bit patterns. When there is a match between the registered bit patterns and the predetermined bit patterns, the modified analog data replaces the data at the output of DACs 808 and 810. By modifying the analog data, overshoot can be avoided without affecting the accuracy of the data transmitted and ultimately received at a transmission destination.

The advantage of modifying the analog data is illustrated by looking at the digital-to-analog conversion process. The conversion process takes a digital string of high and low voltages and transforms them into a sinusoidal analog waveform that accurately represents the data encoded on the digital string. The analog waveform is quantized into a plurality of levels in order to improve accuracy. The digital data is then grouped into input frames of a length sufficient to represent a particular level. For example, in one embodiment, the analog signal has 16 levels. Therefore, the digital inputs are grouped 4-bits at a time, because 2⁴=16. Thus, each 4-bit input to DACs 804 and 806 represent a level in the analog output of each DAC. When there is a match, however, between the registered data and the predetermined data, then the modified analog data is read out of lookup table 902. The modified analog data can alter the level of the analog signal for that conversion, without corrupting the information content. This is because the changing of one level will have negligible impact on the overall analog waveform. For the embodiment discussed above, the registered data and predetermined data would obviously be 4-bits wide.

Further enhancement is obtained, in one particular embodiment, due to the fact that the digital data is eight times oversampled. Therefore, each single digital information bit is actually represented by eight bits at the output of baseband processor 802. Thus, the modification is done with a ⅛^{th} bit resolution, lessening the impact on the analog waveform even further.

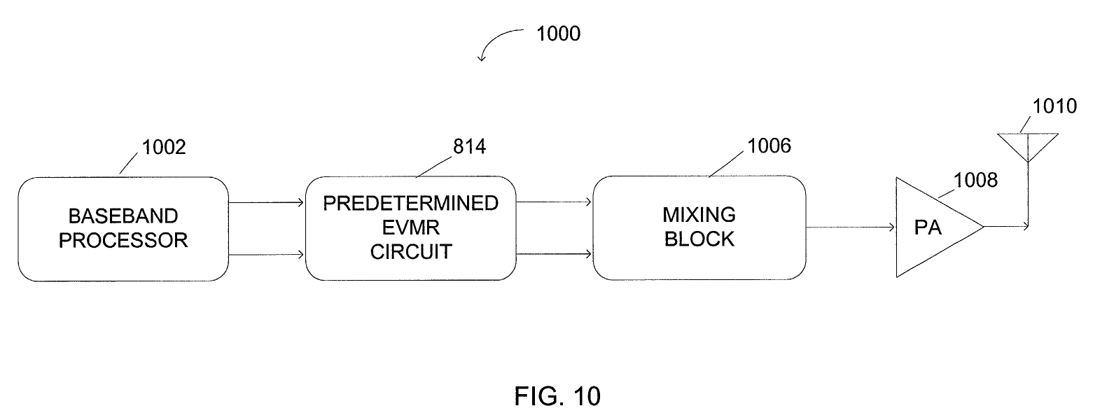

FIG. 10 illustrates a transmitter 1000 that incorporates a predetermined error vector magnitude reduction circuit 814, which is coupled to the output of a baseband processor 1002. The output of circuit 814 is coupled to mixing block 1006, the output of which drives PA 1008 and, subsequently, antenna 1010. The example embodiments above have generally discussed the invention with respect to a mobile station in a wireless communications network. Those skilled in the art will realize, however, that transmitter 1000 can be implemented within a variety of systems. For example, those skilled in the art will realize that any system dependent on preventing overshoot and minimizing EVM will be able to incorporate transmitter 1000. In particular, handsets within a cordless phone system, a wireless local loop, or a satellite communications system are able to utilize transmitter 1000. As such, the embodiments above, as they relate to mobile stations in a wireless communications system, are by way of example only, and are not intended to limit the scope of the invention in any way.

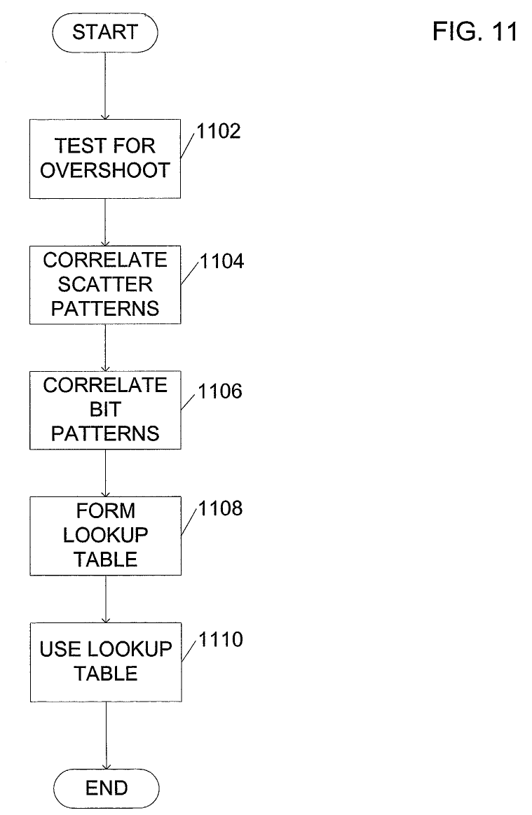

In addition to the above apparatus, there is also provided a method for predetermined error vector magnitude reduction, which is illustrated by the steps in FIG. 11. First in step 1102, testing is done to detect overshoot in a transmitter, such as transmitter 800 or 900 described above. Then, in step 1104, the incidents of overshoot are correlated to specific scatter patterns. These scatter patterns are then correlated to specific digital bit patterns in step 1106. For example, the scatter patterns are correlated to specific inphase and quadrature digital bit patterns generated by a baseband processor 802. Next, in step 1108, a lookup table is formed that comprises the digital bit patterns identified in step 1106, which are referred to as predetermined digital bit patterns, and modified data. The modified data is designed to eliminate the overshoot. Finally, in step 1110, the lookup table is used to eliminate the overshoot during operation of the transmitter.

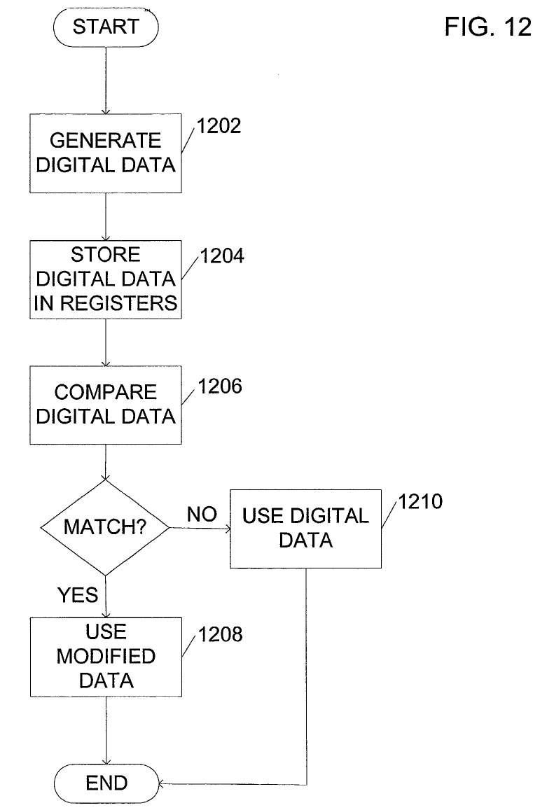

FIG. 12 illustrates one embodiment of a process of using the lookup table to eliminate overshoot. In step 1202, digital data is generated. For example, this data may be digital inphase and quadrature data generated by a baseband processor 802.

Then in step 1204, the digital data is stored in registers, such as registers 804 and 806. The data in the registers is then compared, in step 1206, to the predetermined bit patterns stored in the lookup table. If there is a match, then in step 1208 the modified data in the lookup table is used. If there is no match, then in step 1210 the original digital data is used. Moreover, in one embodiment, the modified data in the lookup table represents modified digital data. In another embodiment, however, the modified data represents modified analog data.

What is claimed is:

1. A predetermined error vector magnitude reduction circuit comprising:
an inphase register for storing digital inphase bit patterns;
a quadrature register for storing digital quadrature bit patterns;
an inphase digital-to-analog converter (DAC) for converting the digital inphase bit patterns to an inphase analog signal;
a quadrature DAC for converting the digital quadrature bit patterns to a quadrature analog signal; and
at least one lookup table containing predetermined digital inphase and quadrature bit patterns for comparison with the digital inphase and quadrature bit patterns stored in the inphase and quadrature registers, and containing modified inphase and quadrature analog data, wherein the modified inphase and quadrature analog data replaces the inphase and quadrature analog signals at the output of the dacs when there is a match between the predetermined digital inphase and quadrature bit patterns stored in the lookup table and the digital inphase and quadrature bit patterns stored in the inphase and quadrature registers.

2. The circuit of claim 1, wherein the inphase and quadrature analog signals are quantized into a plurality of levels, and wherein the modified inphase and quadrature analog signals act to modify a particular level that would otherwise result from a conversion of the inphase and quadrature bit patterns.

3. The circuit of claim 2, wherein the plurality of levels comprises 16 levels.

4. The circuit of claim 1, further comprising a storage element for storing the lookup table.

5. The circuit of claim 4, wherein the storage element is one of a group comprised of a SRAM, a DRAM, an EPROM, an EEPROM, and a Flash.

6. The circuit of claim 1, wherein the predetermined inphase and quadrature bit patterns are preloaded into at least one lookup table.

7. The circuit of claim 1, further comprising an adder for adding the inphase and quadrature analog signals.

8. The circuit of claim 7, wherein the modified inphase and quadrature analog signals are sent to the adder in place of the inphase and quadrature analog signals when there is a match between the predetermined digital inphase and quadrature signals stored in the lookup table and the digital inphase and quadrature signals stored in the inphase and quadrature registers.

9. A predetermined error vector magnitude reduction circuit comprising:
an inphase register for storing digital inphase bit patterns;
a quadrature register for storing digital quadrature bit patterns;
an inphase DAC for converting the digital inphase bit patterns to an inphase analog signal;
a quadrature DAC for converting quadrature bit patterns to an analog signal; and
at least one lookup table containing predetermined digital inphase and quadrature bit patterns for comparison with the digital inphase and quadrature bit patterns stored in the inphase and quadrature registers, and containing modified inphase and quadrature bit patterns, where the modified inphase and quadrature bit patterns replace the digital inphase and quadrature bit patterns at the input of the DACs when there is a match between the predetermined digital inphase and quadrature bit patterns stored in the lookup table and the digital inphase and quadrature bit patterns stored in the inphase and quadrature registers respectively.

10. The circuit of claim 9, further comprising a storage element for storing the lookup table.

11. The circuit of claim 10, wherein the storage element is one of a group comprised of a SRAM, a DRAM, an EPROM, an EEPROM, and a Flash.

12. The circuit of claim 9, wherein the predetermined inphase and quadrature bit patterns are preloaded into the lookup tables.

13. The circuit of claim 9, wherein the lookup table is implemented in software.

14. A transmitter comprising:
a baseband processor for generating inphase and quadrature digital bit patterns;
a predetermined error vector magnitude (EVM) reduction circuit for converting the inphase and quadrature digital bit patterns to analog signals that minimize EVM by correlating the inphase and quadrature digital bit patterns to known EVM scatter patterns;
a mixing stage for mixing the analog signal up to an RF signal;
a power amplifier for amplifying the RF signal; and
an antenna for transmitting the RF signal.

15. The transmitter of claim 14, wherein the predetermined error vector magnitude reduction circuit comprises:
an inphase register for storing the digital inphase bit patterns;
a quadrature register for storing the digital quadrature bit patterns;
an inphase DAC for converting the digital inphase bit patterns to an inphase analog signal;
a quadrature DAC for converting quadrature bit patterns to an analog signal; and
at least one lookup table containing predetermined digital inphase and quadrature bit patterns for comparison with the digital inphase and quadrature bit patterns stored in the inphase and quadrature registers, and containing modified inphase and quadrature analog signals, wherein the modified analog inphase and quadrature analog data replace the inphase and quadrature analog signals at the output of the DACs when there is a match between the predetermined digital inphase and quadrature bit patterns stored in the lookup table and the digital inphase and quadrature bit patterns stored in the inphase and quadrature registers respectively.

16. The transmitter of claim 15, wherein the inphase and quadrature analog signals are quantized into a plurality of levels, and wherein the modified inphase and quadrature analog signals act to modify the particular level that would otherwise result from the conversion of the inphase and quadrature bit patterns.

17. The transmitter of claim 14, wherein the predetermined error vector magnitude reduction circuit comprises:
an inphase register for storing the digital inphase bit patterns;
a quadrature register for storing the digital quadrature bit patterns;
an inphase DAC for converting the digital inphase bit patterns to an inphase analog signal;
a quadrature DAC for converting quadrature bit patterns to an analog signal; and
at least one lookup table containing predetermined digital inphase and quadrature bit patterns for comparing with the digital inphase and quadrature bit patterns stored in the inphase and quadrature registers, and containing modified inphase and quadrature bit patterns, wherein the modified inphase and quadrature bit patterns replace the digital inphase and quadrature bit patterns at the input to the DACs when there is a match between the predetermined digital inphase and quadrature bit patterns stored in the lookup table and the digital inphase and quadrature bit patterns stored in the inphase and quadrature registers respectively.

18. The transmitter of claim 14, wherein the mixing stage comprises a first mixer for mixing the analog signal to an intermediate frequency, followed by a second mixer wherein the intermediate frequency signal is mixed with an RF carrier to create an RF signal.

19. The transmitter of claim 14, wherein the transmitter is included in a handset that is part of a system from a group comprised of a wireless communications system, a cordless telephone system, a wireless local loop, and a satellite communications system.

20. A method for predetermined error vector magnitude reduction comprising the following steps:
testing to detect overshoot in transitions from one phase state to another at the output of a transmitter;
correlating the overshoot to particular error vector magnitude scatter patterns;
correlating the scatter patterns to particular inphase and quadrature bit patterns;
forming a lookup table containing the predetermined inphase and quadrature bit patterns and modified inphase and quadrature data for each of the bit patterns that does not cause overshoot; and
using the lookup table to prevent or reduce error vector magnitude at the output of the transmitter.

21. The method of claim 20, wherein the step of using the lookup table further comprises the steps of:
generating inphase and quadrature bit patterns;
storing the inphase and quadrature bit patterns as stored inphase and quadrature bit patterns;
comparing the stored inphase and quadrature bit patterns to the particular bit patterns; and
using the modified inphase and quadrature data when there is a match between the stored inphase and quadrature bit patterns and the particular inphase and quadrature bit patterns.

22. The method of claim 20, wherein the modified inphase and quadrature data is digital data.

23. The method of claim 20, wherein the modified inphase and quadrature data is analog data.
